(19) United States
(12) Patent Application Publication
(10) Pub. No.: US 2004/0038609 A1
(43) Pub. Date: Feb. 26, 2004

(54) Fabric with oriented and selective activity, in particular antibacterial, method for making same, and uses

(76) Inventor: Hugues-Arnaud Mayer, Aurillac Cedex (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/363,923

(22) PCT Filed: Aug. 21, 2001
(86) PCT No.: PCT/FR01/02647

(30) Foreign Application Priority Data
Sep. 8, 2000 (FR) 00/11616

(51) Int. Cl. D04H 1/00; B32B 27/04; D04H 3/00; D04H 5/00; B32B 5/02; D06C 11/00; B05D 1/14

(52) U.S. Cl. 442/123; 442/121; 442/203; 442/312; 442/415; 442/381; 428/90; 428/91

(57) ABSTRACT

This invention consists of “orienting” the activity (or activities) of textiles, in particular their antimicrobial activity, as well as antistatic, antifungal, and similar useful functions, the “orientation” of the activity (or effect or functions, these terms being used here as being equivalent) of a textile, and especially of the antibacterial activity, of one side of the textile being carried out in relation to the other side.

So-called two-sided fabrics are obtained one of the sides of which is characterized by biological activity (antibacterial, antimicrobial, anticarian insecticide, fungicidal, or generally antiparasitic), cosmetic, pharmaceutical, antistatic, antibacterial in controlled amounts, while the other side may be characterized by zero activity. In the preferred embodiment the technique known as satin weaving or serge weaving is applied in order to orient the fabric as claimed for the invention.

### TECHNICAL SECTOR OF THE INVENTION

This invention relates to the technical sector of textiles, fabrics in particular, exhibiting a special effect or function, especially an antimicrobial and antibacterial effect (or function).

### PRIOR ART

In the context of the constant struggle against nosocomial infections in hospitals, hygiene in industry, hotel keeping, or in the broad public sector, textiles are regarded as being potential significant reservoirs of bacteria and are believed to permit transmission of germs by vectors such as carrying by hand.

A certain number of techniques are currently available for controlling the bacteria present on a textile:

dressing or enhancement, by restoring the integrity of the structure of a fabric or by effecting attachment especially to certain types of fibers making up the textile. The cost of such treatment is relatively low.

Use of threads, fibers, or filaments of all kinds into which diffusing antibacterial agents have been incorporated.

They may be mixed with other materials and then converted to thread and then to a fabric or to cloth of any kind.

The mode of antibacterial operation of these two technologies is to treat the entirety of the structure of the fabric and to render it antibacterial by diffusion of active principles on the non-antibacterial constituents.

The article “Les textiles antimicrobiens,” Pour la Science, No. 266, 1999 is cited as providing general information on this subject.

In existing techniques fabrics are rendered active by treatment either by

impregnation (a fabric is sized, that is, dipped in sizing) or

inclusion (the element is included in the polymer before spinning and weaving)

Whichever technique is applied, the activity of the fabric is the same on both sides, that is, it is not differentiated.

Associated Problems:

In connection with the method of treatment undesirable effects and/or the following problems are encountered

antibacterial characteristics over the mass as a whole and on all sides of the textile.

spreading of the bacterial agents in the environment by bleeding (onto the surface of the skin, for example).

spreading during washing, by perspiration.

probable thinning out of the antibacterial agents more or less in the long term.

possibility of assisting bacterial strains resistant to the agent or in that contact with increasingly weaker doses creates the possibility of creation of mutated species of bacteria as a result of bleeding (something which has already happened, as is stressed in the article referred to).

A serious problem arises for

persons coming into contact with these products on a regular basis: patients, medical care personnel, operating surgeon in the environment to be treated.

persons exposed to a potential risk of overdosage (or of creation of bacterial resistance resulting from repeated exposure).

(Except on fabrics coated on one side, since one side may be deactivated by covering the fabric, by coating or lining, or a two-component fabric=complexing of two fabrics one on the other, but coated fabrics are not absolutely necessary for attainment of the object of this invention).

The need also arises of not destroying non-pathogenic flora and so of not treating areas not affected by infection.

### SUMMARY OF THE INVENTION

In its most general aspect this invention consists of “orienting” the activity (or activities) of fabrics, and especially their antibacterial activity, but also antimicrobial, antistatic, antifungal, and similar useful functions in the fields indicated or which are to be indicated.

It is claimed for the invention that the “orientation” (or effect or function, these terms being equivalent, as the expert will understand) of the textile, and especially of the antibacterial activity, is performed on one side of the textile relative to the other.

So-called “two-sided” fabrics are obtained one of the sides of which will be antibacterial (or antimicrobial, antifungal, antistatic, etc) with metered dosage, while the other side may be characterized by zero antibacterial (or antimicrobial, antifungal, antistatic, etc) activity.

The activities are cited in the following, as non-restrictive examples.

biological activity: activity not due to the mechanical characteristics of the fabric, but

“anti”=in one way or another making it possible to obtain a biological property (antibacterial, antimicrobial, antiacarian, insecticidal, fungicidal, or antiparasitic in general),

“pro”=permitting implantation or growth of the same parasites on the backing.

cosmetic activity: feeling of comfort, well-being, emitting a scent, neutralizing odors, invigorating, removing perspiration and heat).

pharmaceutical activity: in the sense of care resulting from contact with pharmacologically active elements contained in the fabric and provided by spreading, continuously or over a brief period.

antistatic

Throughout this application, including the claims, the overall effect will be designated as “activity” or “function” or sometimes, for the sake of simplification, “antibacterial activity” or “antimicrobial activity” or “antifungal activity,” but in all instances, unless the opposite is specifically indicated, the term used will apply to all the activities described in the foregoing, as well as to those which may occur to the expert, including activities which may appear in the future (new chemical agents, for example).

In order to effect the orientation of the fabric claimed for the invention, use will be made in the preferred embodiment of the technique called SATIN weaving or SERGE weaving.

Use may also be made of the following known techniques:

knitting: in one double-sided fabric (such as the jersey, especially the jersey of cotton mixed with wool, or other fabric)

non-woven: use of two-component fibers or mixing of several types of threads, lining, or any type of fixing of materials by a single effect: mechanical, air jet, water jet, thermal bonding, chemical bonding, lining with wadding, or simple superimposition.

on woven fabric/knitted or non-woven fabric: coating, flocking, micro-encapsulation on the fabric.

satin jacquard weaving,

as well as any technique, including ones which may appear in the future, permitting differentiation of a weft thread from a warp thread, or the opposite, as will be described below. These techniques are or will be well known to the expert.

The invention thus relates to textiles performing a specific function or effect, characterized in that such function is oriented on one side of the textile relative to the other side.

The term “oriented” as used here is to be understood to mean that one of the sides performs such function while the other does not, or that one of the sides performs such function to a certain degree, for example, normal or high, and the other side to another degree, for example, very low or zero, or again that both sides perform one or more functions, one of these sides combining several functions.

To illustrate the last-named case the example may be cited of one side performing an antibacterial function combined with a perspiration removal effect and the other side exhibiting no activity, or a different activity, or only one of the activities cited above, that is, either antibacterial effect or perspiration removal effect.

Mention is to be made of a well-known problem of excessive cost associated with the SATIN or SERGE weaving, which is slower than the conventional warp and weft weaving, a problem which might discourage the expert from considering use of this method.

In addition, there are several types of SATIN and SERGE weaves. Hence neither the choice of the type of weaving, that is, selection of the “active” weft threads, nor evaluation of the prospects of success has been obvious.

### DETAILED DESCRIPTION OF INVENTION

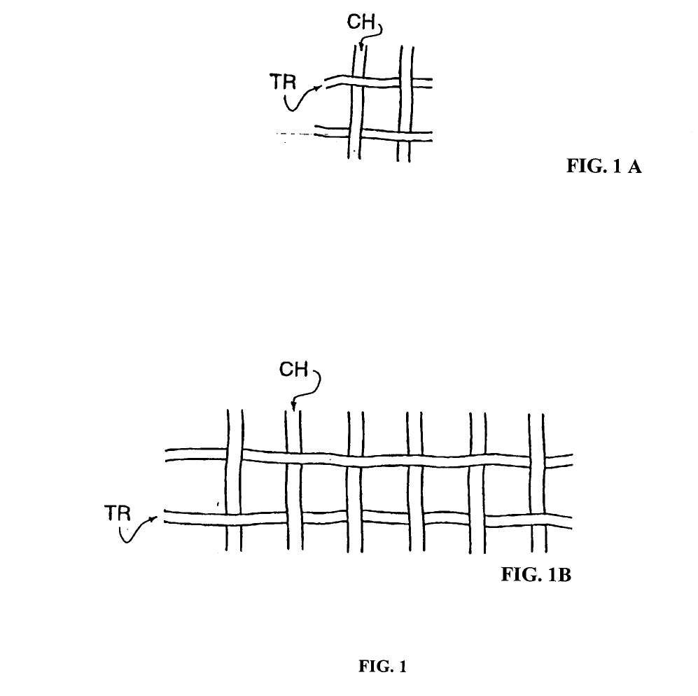

FIG. 1 appended hereto, consisting of FIGS. 1A and 1B, presents a comparative description of a normal fabric relative to a satin or serge weave.

In a normal weaving process (FIG. 1A) each thread (warp CH and weft TR thread respectively) is alternatively in front of and behind the plane of the figure.

In a process of the satin or serge weaving type (FIG. 1B), the warp material CH is moved from one side (“front” in the figure) and the weft material TR from the other side (“rear” in the figure).

Consequently, a front or upper side and a rear or lower side are obtained.

In its general aspect this invention consists of designing a textile characterized in that the two sides do not exhibit the same activity and/or the same degree of a certain activity, in order to solve the problems referred to in the foregoing.

In one particular aspect, the invention consists of a textile the two sides of which do not exhibit the same activity and/or the same degree of a certain activity.

Again in one particular aspect, the invention consists of a textile the two sides of which do not exhibit the same activity and/or not the same degree of a certain activity, and which has been obtained by a manufacturing process of the “satin” type.

In one specific embodiment of the invention the textile is characterized in that it consists of weft threads and of warp threads not exhibiting the same activity, and/or not the same degree of a certain activity, ones woven by the “satin weave” process.

In another embodiment of the invention the warp thread is inactive and the weft thread exhibits a specific activity.

In another embodiment of the invention the weft thread is inactive and the warp thread exhibits a specific activity.

In another embodiment of the invention the warp thread exhibits a certain specific activity A1 and the weft thread a second specific activity A2.

In an alternative embodiment of the invention the warp thread exhibits a certain activity A1 to a certain degree D1 and the weft thread exhibits the same activity A1 to a degree D2.

In one alternative embodiment D1 is a normal degree of activity while D2 is a very low degree.

In a preferred embodiment the specific activity is an antibacterial or antifungal activity.

In an alternative embodiment the specific activity is antistatic activity.

In yet another alternative embodiment A1 is an antibacterial or antifungal activity, while A2 is an antistatic or deodorant or perfuming activity.

In yet other alternative embodiments the A1 and A2 activities are selected from the following, in combinations which will appear appropriate to the expert:

biological activity: activity not due to the mechanical properties of the fabric but:

“anti”=in one way or another making it possible to obtain a biological quality (antibacterial, antimicrobial, antiacarian, insecticidal, fungicidal, or antiparasitic in general),

“pro:=permitting introduction or growth of these same parasites on the backing.

cicatrizing activity

cosmetic activity: feeling of comfort, well-being, emitting a scent, neutralizing odors, invigorating, removing perspiration and heat.

pharmaceutical activity: in the sense of care resulting from contact with pharmacologically active elements contained in the fabric and provided by spreading, continuously or over a brief period.

antifungal activity

antistatic activity

The following activities and combinations of activities may be cited as being preferred but not restrictive:

various biological activities (antifungal, antibacterial, antimicrobial, antiacarian, insecticide, etc.)

combination of biological and mechanical activity (strength, resistivity, rigidity, thickness),

combination of biological and structural activity (comfort, thermal control and impermeability, antiperspirant, flame retardant),

combination of biological and cosmetic activity. For example, antibacterial dressing on one side and dressing soothing pain on the other.

combination of biological and pharmaceutical properties.

fire-resistant activity and: either flame retardation and/or thermal protection, or protection against water or any aqueous liquid, on one side, and activity allowing passage of perspiration on the other side.

and other combinations which will be obvious to the expert.

As has already been stated, it is to be noted that, in accordance with the invention, the effect on the two sides may be either

identical, but to different degrees,

complementary,

different (either two active sides, each performing a different function (or even the same function but to different degrees) or one active and one inactive side).

This technology is original because of the fact that the fabric is oriented, that is, it is very active on one side (easy to identify because it shines, as a result of the SATIN weave, for example) and characterized by low activity on the other in the case of at least one specific function. If the activities of the warp and weft threads are reversed, it is the matte side which will be active.

Hence it is possible to position a fabric with one active side in contact with the patient, for example, a cloth beneath the patient, if the infection is situated under the patient, and to position the top cloth with its inactive side oriented toward the patient.

In one embodiment the fabric comprises two sides:

an active side oriented toward the area to be treated (wound, scar, focus of infection, infection, or the area outside the body from which the attack proceeds),

inactive side oriented toward the areas to be preserved (not to be exposed to an effect such as antibacterial or superfetatory activity), with the possible differences and possible combinations indicated above.

Applications of the Invention:

The activities and combinations of activities such as referred to above (assigned to the weft thread, for example) are the following”

Hospital clothing and fabrics (intended for personnel, patients, etc) and others (curtains, hazardous material clothing; agricultural food and pharmaceutical industries; test laboratories, sterile rooms, including those in industry, white rooms, army, public at large, sports clothing, clothing for hunting (odor abatement effect), industries producing scents, outdoor sports clothing and articles, stain-resistant clothing (automotive repair shop workers, BTP workers, chemical industries, cooking), employee uniforms (hostesses, waiters, etc) and the like, bed linen, furniture fabrics (for houses, vehicles, etc.),

and any protective fabric which may cover a person completely or partly, a tool or equipment (surgical, for example), a clothing accessory, footwear (such as stain-resistant or water-resistant, etc.), fabric to protect sensitive material (electronic equipment, weapons, etc.)

(with the possibility of combination with a secondary activity such as deodorizing or perfuming, assigned to the warp thread, for example).

Other characteristics and advantages of the invention will be better understood by reading the following description and by referring to the appended drawing, in which

FIG. 1, consisting of FIGS. 1A and 1B, as stated in the foregoing represents a comparative description of a normal weave as against a satin or serge weave,

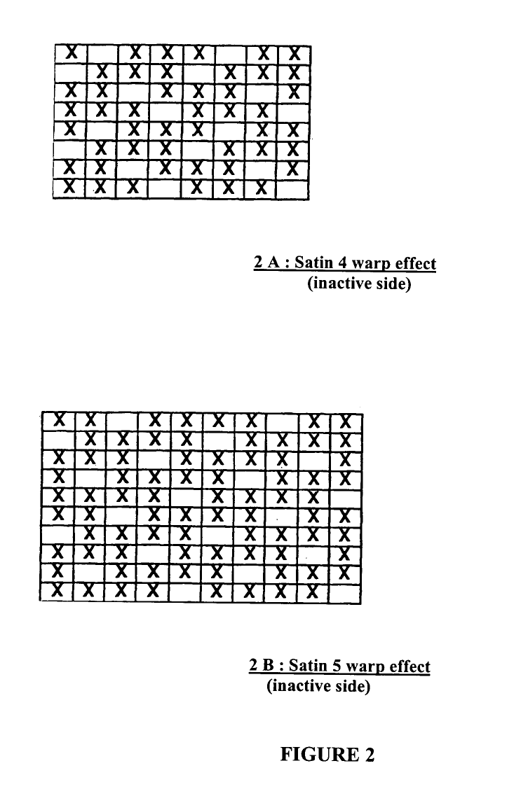

FIG. 2, consisting of FIGS. 2A and 2B, represents a graphic display of warp effect armures obtained by the SATIN technique.

The letters “X” represent the warp threads and the blank squares weft threads.

FIG. 2A: Satin 4 warp effect (inactive side)

FIG. 2B: Satin 5 warp effect (inactive side)

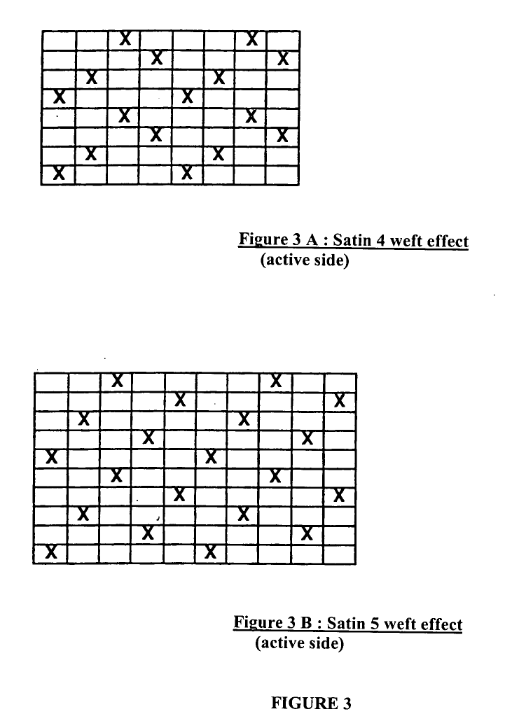

FIG. 3, consisting of FIGS. 3A and 3B, represents a graphic display of weft effect armures obtained by the SATIN technique.

The letters “X” represent the warp threads and the blank squares weft threads.

FIG. 3A: Satin 4 weft effect (active side)

The most interesting product (because of antibacterial property relative to wear resistance)

FIG. 3B: Satin 5 weft effect (active side)

Excellent antibacterial property, but not as wear-resistant

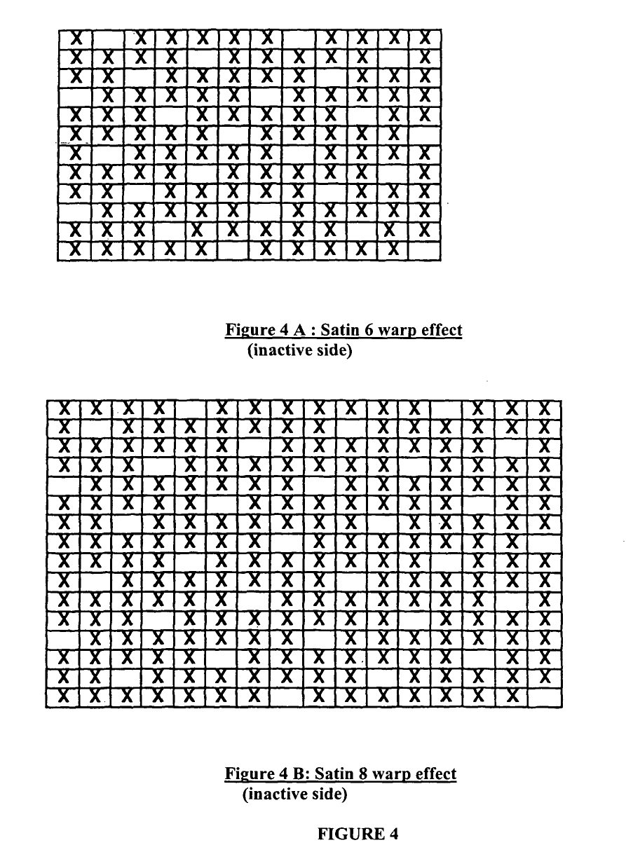

FIG. 4, consisting of FIGS. 4A and 4B, represents a graphic display of warp effect armures obtained by the SATIN technique.

The letters “X” represent the warp threads and the blank squares weft threads.

FIG. 4A: Satin 6 warp effect (inactive side)

FIG. 4B: Satin 8 warp effect (inactive side)

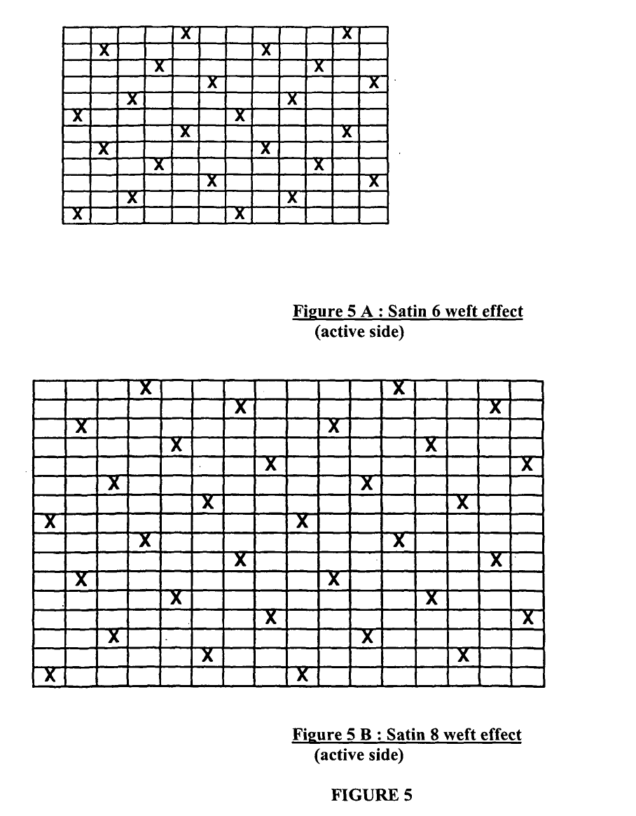

FIG. 5, consisting of FIGS. 5A and 5B, represents a graphic display of weft effect armures obtained by the SATIN technique.

The letters “X” represent the warp threads and the blank squares weft threads.

FIG. 5A: Satin 6 weft effect (active side)

FIG. 5B: Satin 8 weft effect (active side)

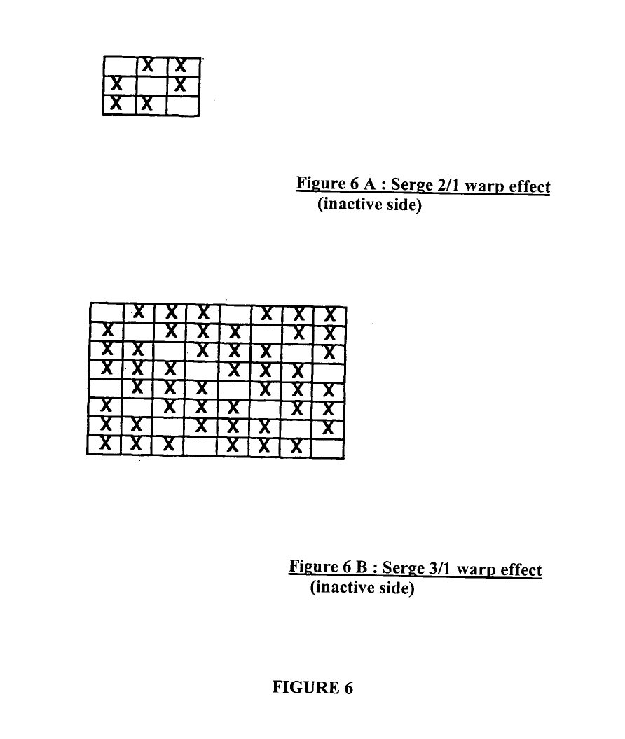

FIG. 6, consisting of FIGS. 6A and 6B, represents a graphic display of warp effect armures obtained by the SERGE technique.

(In this instance use will be made by preference of a 2/1 or 3/1 serge to obtain a maximum of weft threads on one side relative to the other)

The letters “X” represent the warp threads and the blank squares weft threads.

FIG. 6A: Serge 2/1 warp effect (inactive side)

FIG. 6B: Serge 3/1 warp effect (active side)

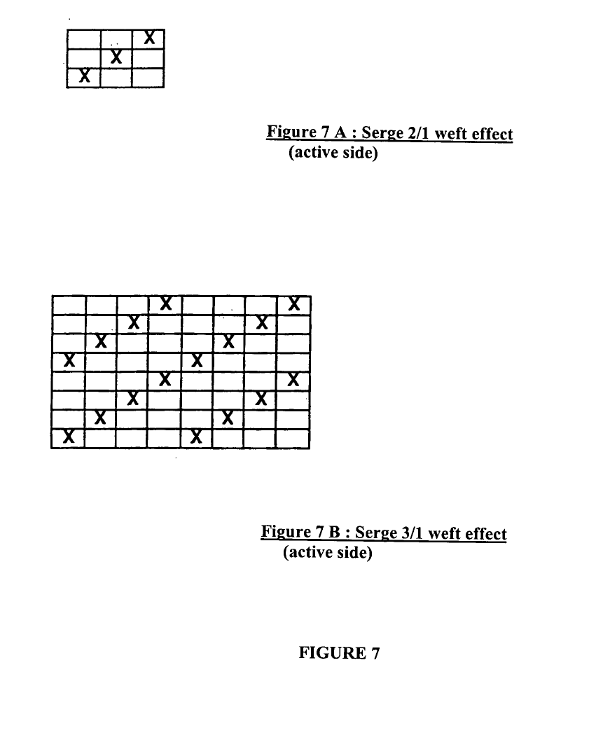

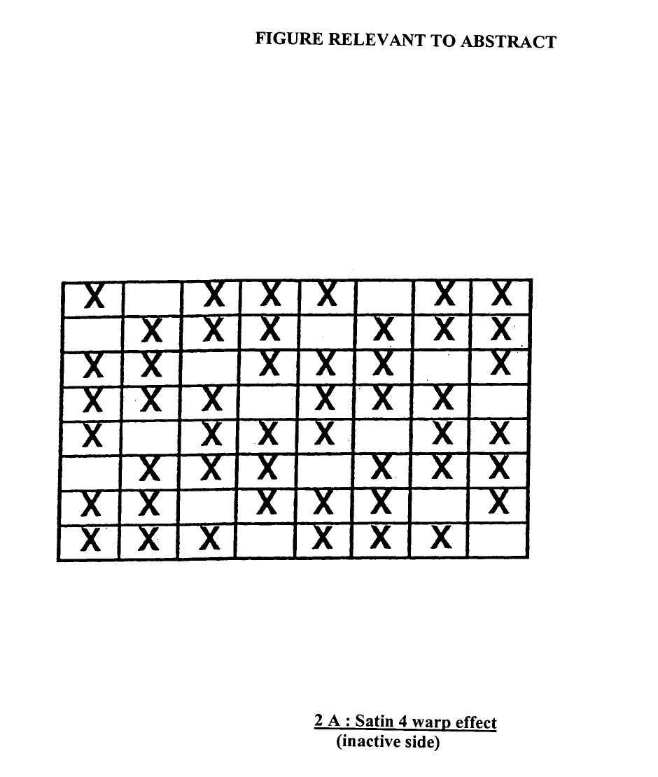

FIG. 7, consisting of FIGS. 7A and 7B, represents a graphic display of warp effect armures obtained by the SERGE technique.

(In this instance use will be made by preference of a 2/1 or 3/1 serge to obtain a maximum of weft threads on one side relative to the other)

The letters “X” represent the warp threads and the blank squares weft threads.

FIG. 7A: Serge 2/1 warp effect (active side)

FIG. 7B: Serge 3/1 warp effect (active side)

The most interesting product as regards relationship of antibacterial property to wear resistance.

### EXAMPLES

Exact Composition of the Fabric:

The warp thread may be made up of 100-percent cotton or 100-percent polyester or a polyester/cotton mixture, filaments or fibers, or of other materials (polyamide, acrylic, etc).

Choice of Materials:

The choice of materials (fibers or filaments) containing antibacterial or antimicrobial agents will be made in accordance with the criterion of non-diffusion of active agents in the environment, and so ones characterized by antibacterial or antimicrobial effect strictly in contact with the fibers.

Choice of Design Techniques:

Choice of textile design techniques will be guided by the point presented above.

Use will be made for this purpose in the preferred configuration of the satin weave technique or the serge weave technique.

The choice of these techniques is determined by the possibility of applying a maximum amount of fibers to one side relative to the other as a function of the use intended to be made of the textile (clothing, sacks, protective covers, curtains, etc).

Technique in Detail:

Definition of Weft Thread:

In order to be able to apply a maximum amount of antibacterial or antimicrobial agents to one of the sides, we have decided to utilize antibacterial or antimicrobial agents in the weft thread by producing mixtures of active threads or filaments with inactive fibers or filaments to which agents are prepared uniformly on the basis of the effectiveness desired.

Choice of SATIN Technique:

A 4 or 5 satin may be used (above all for the resistance consideration), as a function of the resistance, comfort, or dosage criteria. See FIGS. 1A-1B and 1A′ and 1A″.

+ or − resistant.

The other techniques permit production of double-sided weaves (lining, coating, etc.); they are accordingly more costly or modify the characteristics of the weave (flexibility, washability, stability, comfort).

The weft thread will be prepared as a function of the performance needs associated with the final product utilizing the fabric. The latter may be made up of threads, fibers, or filaments based on cotton, polyester, a mixture or other fibers or on other pure or mixed materials.

The qualities of the textile may be linked to the nature of the fibers or filaments making up the thread, but may also result from an enhancement treatment which may be carried out with a thread made up of materials which by their nature possess no specific properties.

Example: insecticide treatment of a weft thread of pure cotton for an article of hunting dress.

Example: an antibacterial fiber included in a thread made up of a comfort fiber of the Coolmax™ type.

The weaving techniques will make it possible to impart a maximum of antibacterial or antimicrobial efficiency to one of the sides selected, the side termed “active.” The efficiency on this side may range from slightly bacteriostatic or microbiostatic to very highly bactericidal or microbicidal, depending on the final use intended.

As regards the other side, the weaving techniques will make possible an activity varying over the same range, that is, from zero to highly active. Consequently, the fabrics will be either active on one side or active on both sides.

As regards the other side, the weaving techniques will permit, for example, quasi bacteriological or other activity or no activity at all. The activity of this other side will range from slight bacteriostatic (or other activity) to no activity.

Activities termed biological, pharmaceutical, cosmetologic and/or combined with mechanical, structural properties and qualities of physical comfort may be applied and combined in the same proportions, that is, from very low to very high.

The weaving techniques used may be those in use for production of fabrics customarily used in their usage context. The techniques may vary, from weaving, knitting, non-weaving production, to any other technique permitting superimposition or production of a double-sided textile material.

In an antistatic or other application, the foregoing statements are valid, allowance being made for the respective differences.

Areas of Application:

increase or decrease in the number of warp or weft threads,

different SATIN pattern (the satin 4 fabric is preferably selected as being more lasting, the satin 5 fabric as being more efficient, than the satin 6 and 8 fabrics, which are less preferable).

different SERGE pattern (the satin 2/1 3/1 are selected for their wear resistance and their efficiency).

Choice of the Active Fiber or Filament:

Use is made of a fiber or filament made up of a polymer saturated with an active agent mixed thoroughly with the mass of the fiber or filament in its entirety (and exerting its effect, in the case of antibacterial agents, by ion exchange or any similar technology).

All these fibers are thought not to spread their active agent by releasing it into their environment.

In addition, the effectiveness over the entire physical life of the product has been proved. It is washable at all temperatures and nontoxic.

Active Agents:

These agents are known to the expert, each in his own sphere of activity.

Reference is made to the article cited above in POUR LA SCIENCE, No. 266, December 1999, pages 134 et seq., “Antimicrobial textiles,” by F. Renaud and J. Freney.

A large family of antibacterial or antifungal products used in the fibers is that found among the zeolites. well-known compounds which are alumino-silicates bound to silver and copper or silver and zinc ions, the latter ions exerting an antiseptic effect by blocking the thiol groups of proteins, mineral and animal ceramics, amides, or any other agent known for non-diffusion effect resulting from release into its environment.

Other agents are to be found in the following table.

Intensity:

The intensity of effectiveness is a function of a number of criteria known to the expert (see article referred to in the foregoing and the following table).

The invention also covers all embodiments and all the applications which will be immediately understandable to the expert on reading this application, from his own knowledge.

“HEALTH FOR BED LINEN” TEXTILES
2-MITE AND TICK CONTROL TEXTILES

| Classification | Mode of operation/definition | Advantages | Disadvantages |
|---|---|---|---|
| Antifungal agents: mite | Principle: The antifungal molecule | Very low cost | Molecule often |
| and tick “starvers” (first | breaks the food chain of the mite or | No known toxicity | photolabile |
| generation) | tick and starves it. The mite or tick | Slight antibacterial effect before | (destroyed by light) |
| | starves to death after 3 to 6 weeks. | washing or prolonged use | and water-soluble |
| | Use: The molecule is included in a | | (dissolves in water |
| | preparation which is deposited on | | and so disappears |
| | the fabric by fulling. | | immediately on |
| | Examples: First-generation | | washing) |
| | Sanitiuzed ®Actigard ® | | Dry cleaning |
| | | | recommended |
| Non-permanent mite and | Principle: Pyrethrum extracts | Improved durability (relative to 1 | Instability when |
| tick control pyrethrum | (chrysanthemum, geranium) are by | above), | exposed to light |
| extracts | nature mite and tick and insect | Cost not too high | (photolabile) |
| | control agents (in high doses). They | No intrinsic allergenic effect | Slow acting (after 3 |
| | kill mites and ticks. | (is not of itself allergenic). | weeks, during |
| | Use: Deposited in finish | May be combined with an | which the mite or |
| | Example: Microstop ® | antifungal agent | tick may migrate to |
| | Actigard ® Sinacaria ® | | find food elsewhere) |
| | (the latter is combined with | | Washability |
| | Teflon ®) | | (relatively low; |
| | | | maximum of 5 |
| | | | launderings at 40° ). |
| Stabilized, non- | Principle: Permethrine, first insect | Perennial mite and tick control | Price slightly high |
| permanent derivatives of | control molecule in the world (in | agent (antiacarian). | |
| permethrine (second | textile products), also kills mites and | No known toxicity | |
| generation) | ticks, in a lower effective dose. | Sometimes combined with an | |
| | | antifungal agent (slightly | |
| | Use: Deposited in finish, sometimes | antibacterial; see No. 1 above) and | |
| | combined with other molecules. | an agent protecting textiles | |
| | Example: Acaristop ® | (“antistain” agents to prevent | |
| | | formation of stains which may act as | |
| | | “pantries” for the mite or tick. | |
| | | Washable 10 times at 600( on basis | |
| | | of current formulation, with | |
| | | advances to be expected). | |
| | | Photostable. | |
| | | Rapid-acting: 48 hours. | |

“HEALTH FOR BED LINEN” TEXTILES
1-ANTIBACTERIAL TEXTILES

| Classification | Mode of operation/definition | Advantages | Disadvantages |
|---|---|---|---|
| Finishes | Deposit of a mixture of more or less | Inexpensive | Very short-term |
| | complex mixture of active | | activity in situ (low |
| | molecules on a textile (method: | | fixation) |
| | impregnation, padding). | | Poor behavior in |
| | Example: Sanitized ® (derived from | | laundering |
| | penoxyaogenes + | | Salting out (the |
| | isothiazolinone). | | molecules are |
| | | | disengaged and |
| | | | diffused) |
| Inclusions accompanied | Integration into polymer of a | Use of an excellent non-toxic and | Diffusing product |
| by diffusion | molecule which is active but may | active molecule (Triclosan). | (salting out to be |
| | exhibit salting out (diffusion, even if | Washable at 60°. | overcome ) = |
| | limited) | Development possibilities | negative support |
| | Examples: | (trimming fiber, thread, fabric, | High costs |
| | Rhovyl AS ®(active principle: | etc.). | associated with |
| | Triclosan into the chlorinated | Marketing support | marketing support |
| | fiber, | | |
| | Hollofil Allerband ®(active | | |
| | principle: Triclosan integrated | | |
| | into the acrylic plastic, the entire | | |
| | assembly mixed with 9 parts | | |
| | polyester). | | |
| | Microsafe ® (Irgasan) | | |
| Inclusions not | Integration into a polymer of an | Use of active, non-toxic, well-fixed | High cost |
| accompanied by | active non-diffusing molecule | (non-diffusing) zeolites. | “Small and Medium |
| diffusion | Examples: | Washable at 60° (95° for | Size Enterprise” |
| | Bactekiller ®Bactistop ®, No- | certain applications) | marketing. |
| | Bacte ®(active principle: zeolites | Development potential. | |
| | releasing active oxygen O₂ | “In vivo” scientific support. | |
| | integrated into polyester) | | |
| | Bactistop ® Filling | | |
| | New filling fiber. | | |
| | Antibacterial substance, non- | | |
| | diffusing and washable | | |

1. Textiles exhibiting at least one specific function or effect, characterized in that such function is “oriented” as a function of one side of the textile relative to the other side, that is, one of the sides exhibits at least one such function to a certain degree and the other side to another degree, and in that such textile is obtained by
any technique permitting differentiation of a weft thread from a warp thread, such as SATIN weave, a SERGE weave or Jacquard satin weave.
knitting: on one double side, such as a jersey, in particular a plaited jersey.
non-woven: with two-component fibers or mixture of several types of threads, lining, or any method of fixing materials by one effect: mechanical, air jet, water jet, thermal bonding, chemical bonding, wadding, or simple superimposition. p1 oating, flocking, microencapsulation on a textile of the woven fabric/non-woven knitted fabric type.

2. Textiles as claimed in claim 1, wherein at least one of the sides exhibits several functions.

3. Textiles as claimed in claim 1, wherein such function or functions is or are selected from among the following:
biological activity: activity not due to the mechanical characteristics of the fabric but:
“anti”= making it possible in one way or another to obtain a biological property (antibacterial, antimicrobial, antiacarian (permitting mite and tick control), insecticidal, fungicidal, or antiparasitic in general),
“pro”= permitting implantation or growth of the same parasites on the backing.
Cosmetic activity: feeling of comfort, well-being, emitting a scent, neutralizing odors, invigorating, draining perspiration and heat).
Pharmaceutical activity: in the sense of care resulting from contact with pharmacologically active elements contained in the fabric and provided by spreading, continuously or over a brief period.
Antistatic
Cicatrizing

4. Textiles or fabrics as claimed in any of claims 1 to 3, wherein such textiles or fabrics are two-sided, one of the sides exhibiting an activity selected from among the following: antibacterial, antimicrobial, fungicidal, antistatic, antiacarian, insecticidal, antiparasitic, in metered dosage, while the other side exhibits an activity selected from among the following: antibacterial, antimicrobial, antifungal, antistatic, antiacarian, insecticidal, antiparasitic, zero.

5. Textiles as claimed in any of claims 1 to 4, wherein one side exhibits a antibacterial effect combined with a perspiration removal effect, and the other side no activity.

6. Textiles as claimed in any of claims 1 to 5, wherein the the warp material CH is displaced from one side (“front”) the weft material TR is displaced from the other side (“back”), or conversely.

7. Textiles as claimed in any of claims 1 to 6, wherein the two sides do not exhibit the same activity.

8. Textiles as claimed in any of claims 1 to 6, wherein the two sides do not exhibit the same degree of a certain activity.

9. Textiles as claimed in any of claims 1 to 8, wherein such textiles consist of weft threads and warp threads not exhibiting the same activity.

10. Textiles as claimed in any of claims 1 to 8, wherein such textiles consist of weft threads and warp threads not exhibiting the same degree of a certain activity.

11. Textiles as claimed in any of claims 1 to 10, wherein such textiles are woven by the process termed “satin weaving” or “serge weaving.”

12. Textiles as claimed in any of claims 1 to 11, wherein the warp thread is inactive and the weft thread exhibits a specific activity.

13. Textiles as claimed in any of claims 1 to 11, wherein the weft thread is inactive and the warp thread exhibits a specific activity.

14. Textiles as claimed in any of claims 1 to 13, wherein the warp thread exhibits a certain specific activity A1 and the weft thread exhibits a second specific activity A2.

15. Textiles as claimed in any of claims 1 to 13, wherein the warp thread exhibits a certain activity A1 to a certain degree D1 and the weft thread exhibits the same activity A1 to a degree D2.

16. Textiles as claimed in claim 15, wherein D1 is a normal degree of activity and D2 is a very low degree of activity.

17. Textiles as claimed in claim 14 or 15, wherein A1 is an antibacterial or antimicrobial activity and A2 is an antistatic or deodorizing or perfuming activity, the activities A1 and A2 being selected from among the following combinations:
various biological activities (antifungal, antibacterial, antimicrobial, antiacarian, insecticidal, etc.)
combination of biological and mechanical activity (strength, resistivity, rigidity, thickness),
combination of biological and structural activity (comfort, thermal control and impermeability, antiperspirant, nonflammable),
combination of biological and cosmetic activity, such as antibacterial dressing on one side and a dressing soothing pain on the other.
combination of biological and pharmaceutical properties.
fire-resistant activity and either flame retardation and/or thermal protection, or protection against water or any aqueous liquid, on one side, and activity allowing passage of perspiration on the other side.

18. Textiles as claimed in any of claims 1 to 17, wherein such textiles comprise two sides:
an active side oriented toward the area to be treated (wound, scar, focus of infection, or exterior of the body from which the attack proceeds),
inactive side oriented toward the areas to be preserved (not to be exposed to an effect such as antibacterial or superfetatory activity).

19. Textiles as claimed in any of claims 1 to 18, wherein such textiles are obtained with
satin 4 warp effect (inactive side) or
satin 5 warp effect (inactive side) or
satin 4 weft effect (active side) or
satin 5 weft effect (active side) or
satin 6 warp effect (inactive side) or
satin 8 warp effect (inactive side) or
satin 6 weft effect (active side) or
satin 8 weft effect (active side) or
serge 2/1 warp effect (inactive side) or
serge 3/1 warp effect (inactive side) or
serge 2/1 weft effect (active side) or
serge 3/1 weft effect (active side).

20. Textiles as claimed in any of claims 1 to 19, wherein the warp thread may be made up of 100 percent cotton or 100 percent polyester or a polyester/cotton mixture, filaments or fibers, or of other materials (polyamide, acrylic).

21. Textiles as claimed in any of claims 1 to 20, wherein choice of materials (fibers or filaments) containing antibacterial or antimicrobial agents is made in accordance with a criterion of non-diffusion of active agents into the environment, and therefore of antibacterial or antimicrobial or other effect strictly on contact with the fibers.

22. Textiles as claimed in any of claims 1 to 21, wherein the active agent is selected as being antibacterial or antifungal from among the zeolites, which are alumino-salicates silicates bound to silver and copper or silver and zinc ions, mineral and animal ceramics, or amides.

23. A process of manufacturing a “two-sided” textile or fabric as claimed in one of claims 1 to 22, characterized in that such process employs a technique selected from among the following:
the technique termed SATIN weaving, in particular satin 4, satin 5, satin 6, or satin 8
the SERGE weaving technique, in particular 2/1 or 3/1,
knitting, in one two-sided fabric (such as the jersey, in particular the jersey of cotton mixed with wool, silk, or other material).
non-woven fabric: with two-component fibers or by mixture of several types of
threads, lining, or any method of fixing materials by one effect: mechanical, air
jet, water jet, thermal bonding, chemical bonding, wadding, or simple superimposition.
on a fabric of the woven/knitted or non-woven type: coating, flocking, micro-encapsulation on a textile.
satin jacquard weaving, and any technique making it possible to differentiate a weft thread from a warp thread or conversely.

24. Applications of fabrics and textiles as claimed in any of claims 1 to 22 and by the process claimed in claim 21 to the following:
hospital clothing and fabrics (curtains, hazardous material clothing; agricultural food and pharmaceutical industries; test laboratories, sterile rooms, including those in industry, white rooms, army, public at large, sports clothing, clothing for hunting, industries producing scents, outdoor sports clothing and articles, stain-resistant clothing (automotive repair shop workers, BTP workers, chemical industries, cooking), personnel uniforms (hostesses, waiters, etc) and the like, bed linen, furniture fabrics for houses, vehicles,
and any protective fabric which may cover a person completely or partly, a tool or equipment, a clothing accessory, footwear, to protect sensitive material.

25. Materials, equipment, clothing, characterized in that they are covered by a textile as claimed in any of claims 1 to 22.
